(19) United States
(12) Patent Application Publication
(10) Pub. No.: US 2026/0175739 A1
(43) Pub. Date: Jun. 25, 2026

(54) VEHICLE POWER SUPPLY DEVICE

(71) Applicant: MINEBEA MITSUMI Inc., Kitasaku-gun (JP)

(72) Inventors: Kunihito ASAI, Hiroshima (JP); Yusuke TAKADA, Hiroshima (JP)

(21) Appl. No.: 19/414,544

(22) Filed: Dec. 10, 2025

(30) Foreign Application Priority Data
Dec. 24, 2024 (JP) 2024-227659

(51) Int. Cl. B60L 58/18; B60L 58/12

(52) U.S. Cl. CPC B60L 58/18; B60L 58/12; B60L 2240/547

(57) ABSTRACT

A vehicle power supply device includes an in-vehicle battery mounted on a vehicle, a backup power supply as a spare of the in-vehicle battery, a motor that drives an in-vehicle electric device by being supplied with electric power from the in-vehicle battery or the backup power supply, a charger that charges the backup power supply by supplying the electric power from the in-vehicle battery to the backup power supply, an in-vehicle battery voltage acquirer that acquires an output voltage of the in-vehicle battery, and a controller that controls the charger, in which when the output voltage of the in-vehicle battery becomes less than a first voltage, the output voltage being detected by the in-vehicle battery voltage acquirer, the controller charges the backup power supply so as to output a second voltage with which the motor is at least operable.

### CROSS REFERENCE TO RELATED APPLICATION

This application claims benefit of priority to Japanese Patent Application 2024-227659, filed on Dec. 24, 2024, the entire content of which is incorporated herein by reference.

### BACKGROUND ART

### Technical Field

The present invention relates to a vehicle power supply device.

### Background Art

JP 2009-144441 A discloses a door lock system including a door lock motor that locks and unlocks a door of a vehicle, a battery that is installed in a vehicle body and stores electric power for driving the door lock motor, and a capacitor that is installed in the door, can store electric power for driving the door lock motor, and serves as an auxiliary power supply. The door lock system is configured to drive the door lock motor with electric power stored in the backup power supply in the door in a case where electric power is lost from the battery in the vehicle body.

### SUMMARY

By the way, in the battery mounted on the vehicle, electric power stored by natural discharge or the like is reduced, and an output voltage from the battery falls below a voltage necessary for operating an in-vehicle electric device such as a prime mover and a latch mechanism that unlocks the door, that is, so-called battery exhaustion may occur. When battery exhaustion occurs, there is a problem that the motor for operating the in-vehicle electric device does not operate.

The present invention has been made in view of the above problem, and an object of the present invention is to provide a vehicle power supply device capable of operating an in-vehicle electric device even in a case where battery exhaustion occurs.

One aspect of the present invention provides, as a means to solve the above problem, a vehicle power supply device including an in-vehicle battery mounted on a vehicle, a backup power supply as a spare of the in-vehicle battery, a motor that drives an in-vehicle electric device by being supplied with electric power from the in-vehicle battery or the backup power supply, a charger that charges the backup power supply by supplying the electric power from the in-vehicle battery to the backup power supply, an in-vehicle battery voltage acquirer that acquires an output voltage of the in-vehicle battery, and a controller that controls the charger, in which when the output voltage of the in-vehicle battery becomes less than a first voltage, the output voltage being detected by the in-vehicle battery voltage acquirer, the controller charges the backup power supply so as to output a second voltage with which the motor is at least operable and maintains the output voltage of the backup power supply to be the second voltage.

In the above configuration, even when battery exhaustion occurs, since the electric power is stored in the backup power supply, the motor can be operated by electric power output from the backup power supply to drive the in-vehicle electric device.

The second voltage may be less than the first voltage.

In the above configuration, since the second voltage with which the motor is at least operable is less than the first voltage that is the output voltage of the in-vehicle battery that triggers a start of charging of the backup power supply, the motor can be reliably operated.

The motor may be a low-voltage motor operable in an operation voltage range less than a minimum output voltage of the output voltage of the in-vehicle battery, and the second voltage may be a voltage in the operation voltage range.

The above configuration can reliably operate the motor.

An output voltage when the backup power supply is charged to an upper limit of a capacity of the backup power supply may be greater than the second voltage.

In the above configuration, since the output voltage at the time of full charge (when the backup power supply is charged to the upper limit of the capacity) when the deterioration of the backup power supply progresses is greater than the second voltage necessary for operating the motor, even if the backup power supply is charged to the second voltage, the deterioration of the backup power supply can be suppressed.

A booster that boosts the output voltage of the backup power supply may be further provided, and the backup power supply may supply electric power via the booster to an authenticator that performs authentication by wireless communication with a portable device.

In this configuration, even in a case where battery exhaustion occurs, authentication by the authenticator can be performed.

The vehicle power supply device of the present invention can operate the in-vehicle electric device even when battery exhaustion occurs.

### BRIEF DESCRIPTION OF DRAWINGS

FIG. 1 is a block diagram illustrating a vehicle door device according to an embodiment;

FIG. 2 is a flowchart illustrating processing executed by a controller according to the embodiment; and

FIG. 3 is a flowchart illustrating processing executed by a controller according to a modification.

### DETAILED DESCRIPTION

Hereinafter, an embodiment of the present invention will be described with reference to the drawings. Note that the same or corresponding elements are denoted by the same reference signs throughout the drawings, and overlapping of detailed description will be omitted.

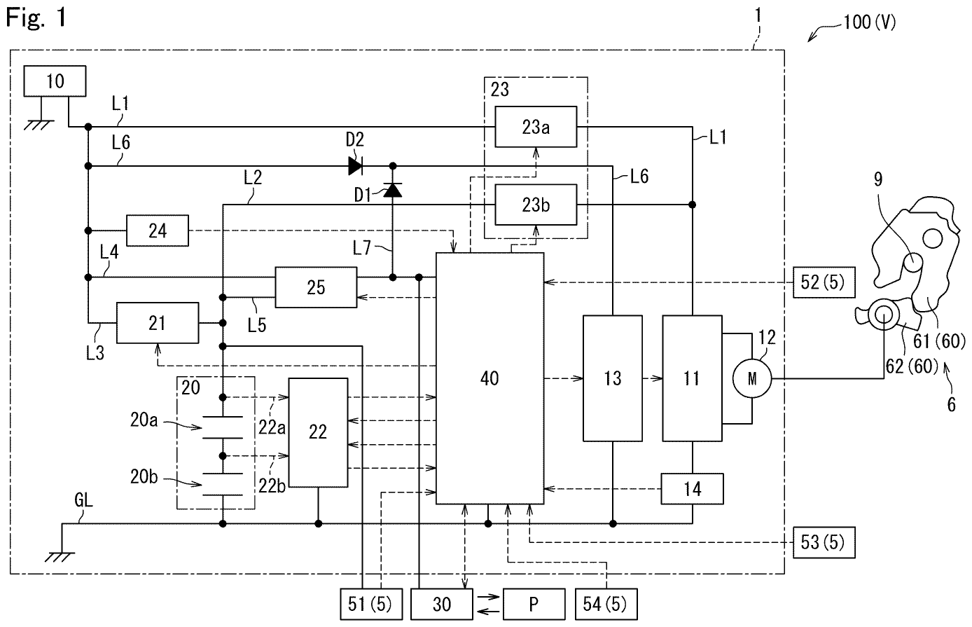

A vehicle door device 100 (hereinafter referred to as a “door device 100”) illustrated in FIG. 1 is mounted on a vehicle V. The door device 100 includes a power supply device 1 (an example of a vehicle power supply device), a signal output unit 5, and a door latch device 6 (an example of an in-vehicle electric device).

### Power Supply Device

The power supply device 1 includes an in-vehicle battery 10, a motor drive unit 11, a motor 12, a pre-driver 13, and a current detector 14. The power supply device 1 includes a backup power supply 20, a charger 21, a discharger 22, a switching unit 23, an in-vehicle battery voltage acquirer 24, a voltage stabilizer 25 (an example of a booster), an authenticator 30, and a controller 40.

Furthermore, the power supply device 1 includes a main feeder line L1, a sub feeder line L2, a charging line L3, a main control power supply line L4, a sub control power supply line L5, a main drive line L6, a sub drive line L7, and a ground line GL, and the current detector 14, the pre-driver 13, the backup power supply 20, the discharger 22, and the controller 40 are grounded via the ground line GL.

### In-Vehicle Battery

The in-vehicle battery 10 is mounted on a vehicle V (vehicle body). The in-vehicle battery 10 is, for example, a lead-acid battery, and can store electric power. The in-vehicle battery 10 can also supply electric power to a prime mover or the like mounted on the vehicle V, other than the motor 12. The nominal voltage of the in-vehicle battery 10 is 12 V, but the output voltage varies, for example, in a range of 9 V to 16 V.

The in-vehicle battery 10 is connected to the motor drive unit 11 via the switching unit 23 by the main feeder line L1, and supplies electric power to the motor drive unit 11.

### Motor Drive Unit

The motor drive unit 11 supplies the supplied electric power to the motor 12. Electric power is supplied to the motor 12 from the in-vehicle battery 10 or the backup power supply 20 via the motor drive unit 11. Electric power is supplied to operate the motor 12, and thus, the door latch device 6 is driven. As a result, a door of the vehicle V can be opened and closed.

### Motor

The motor 12 is a motor that can rotate forward and backward, and is, for example, a DC motor. The motor 12 operates at a voltage in a predetermined range (hereinafter referred to as an operation voltage range). In the present embodiment, the motor 12 is a so-called low-voltage motor, and the operation voltage range of the motor 12 is lower than a minimum output voltage of the in-vehicle battery 10. For example, the minimum output voltage of the in-vehicle battery 10 is 9 V, and the operation voltage range of the motor 12 is from 3 V to 8 V.

### Pre-Driver

The pre-driver 13 adjusts the voltage supplied from the in-vehicle battery 10 to the motor 12 via the motor drive unit 11 to a voltage within the operation voltage range (for example, performs PWM control). The voltage supplied to the motor 12 is adjusted by the pre-driver 13, and thus, the motor 12 can be stably operated even though the in-vehicle battery 10 is selected as a supply source (power supply) of electric power to the motor 12 and a low-voltage motor is adopted as the motor 12. The operation of the pre-driver 13 is controlled by the controller 40.

### Current Detector

The current detector 14 detects a current flowing through the motor 12 and outputs information (signal) indicating a detected current value. In a case where the current value output from the current detector 14 exceeds a predetermined threshold value, the controller 40 determines that an overcurrent has occurred in the motor 12, controls the switching unit 23 to be described in detail later, disconnects the in-vehicle battery 10 and the backup power supply 20 from the motor drive unit 11, and cuts off the current flowing through the motor 12.

### Backup Power Supply

The backup power supply 20 is a power supply as a spare of the in-vehicle battery 10. The backup power supply 20 is provided in preparation for a case where electric power from the in-vehicle battery 10 is cut off due to damage of the vehicle V because of an accident or the like. The backup power supply 20 is disposed, for example, on a door (not illustrated).

The backup power supply 20 is configured by a capacitor. In the present embodiment, the backup power supply 20 is configured by connecting two capacitors 20a and 20b in series. Each of the capacitors 20a and 20b is an electric double layer capacitor.

The output voltage of each of the capacitors 20a and 20b is, for example, 2.5 V to 3 V, preferably 3 V, and the voltage of the backup power supply 20 when the backup power supply 20 stores electric power (charge) up to an upper limit (substantially upper limit) of a capacity (hereinafter referred to as a time of full charge) is from 5 V to 6 V, preferably 6 V. In the backup power supply 20, the stored electric power (charge) decreases due to discharge, and the voltage decreases.

The backup power supply 20 is connected to the in-vehicle battery 10 via the charger 21 by the charging line L3. The backup power supply 20 is charged by an operation of the charger 21 being controlled by the controller 40.

### Charger

The charger 21 supplies electric power from the in-vehicle battery 10 to the backup power supply 20. Accordingly, the backup power supply 20 is charged. Specifically, the charger 21 includes, for example, an opening/closing switch, and in a case where the opening/closing switch is in a closed state, electric power from the in-vehicle battery 10 is supplied to the backup power supply 20. As a result, the backup power supply 20 is charged. On the other hand, in a case where the opening/closing switch is in an open state, the electric power supply from the in-vehicle battery 10 to the backup power supply 20 is stopped, and the backup power supply 20 can be discharged. The operation of the charger 21 is controlled by the controller 40.

### Discharger

The discharger 22 adjusts the voltages of the two capacitors 20a and 20b included in the backup power supply 20 to be equal. The discharger 22 is implemented by two discharge control lines 22a and 22b, for example, an equalization circuit or a cell balance circuit including elements such as resistors and switches. The discharge control lines 22a and 22b connect the controller 40 and the backup power supply 20.

The controller 40 can detect potentials (voltages) of the discharge control lines 22a and 22b. The controller 40 can control the discharger 22 on the basis of the potentials of the discharge control lines 22a and 22b to discharge the backup power supply 20.

The backup power supply 20 is connected to the motor drive unit 11 (motor 12) by the main feeder line L1 and the sub feeder line L2 via the switching unit 23. The operation of the switching unit 23 is controlled, and thus, the backup power supply 20 supplies electric power to the motor 12 instead of the in-vehicle battery 10.

### Switching Unit

The switching unit 23 switches the supply source of electric power to be supplied to the motor drive unit 11 (motor 12) between the in-vehicle battery 10 and the backup power supply 20. The switching unit 23 includes a main switch element 23a and a sub switch element 23b. The operation of the switching unit 23, that is, opening and closing of the main switch element 23a and opening and closing of the sub switch element 23b are controlled by the controller 40.

The main switch element 23a is connected to the main feeder line L1 connecting the in-vehicle battery 10 and the motor drive unit 11. The sub switch element 23b is connected to the sub feeder line L2 connecting the backup power supply 20 and the motor drive unit 11. That is, the motor drive unit 11 is connected to the in-vehicle battery 10 by the main feeder line L1 via the main switch element 23a, and is connected to the backup power supply 20 by the sub feeder line L2 via the sub switch element 23b. The sub feeder line L2 is connected to the main feeder line L1 between the main switch element 23a and the motor drive unit 11.

In a case where the main switch element 23a is in a closed state and the sub switch element 23b is in an open state, electric power from the in-vehicle battery 10 is supplied to the motor drive unit 11. On the other hand, in a case where the main switch element 23a is in an open state and the sub switch element 23b is in a closed state, electric power from the backup power supply 20 is supplied to the motor drive unit 11.

### In-Vehicle Battery Voltage Acquirer

The in-vehicle battery voltage acquirer 24 acquires the output voltage of the in-vehicle battery 10. The in-vehicle battery voltage acquirer 24 is connected to the main feeder line L1, for example, and outputs information (signal) indicating the output voltage of the in-vehicle battery 10.

### Voltage Stabilizer

The voltage stabilizer 25 is connected to the main control power supply line L4 connecting the in-vehicle battery 10 to the controller 40 and the authenticator 30. The voltage stabilizer 25 is also connected to the sub control power supply line L5 connecting the backup power supply 20 to the controller 40 and the authenticator 30. Furthermore, the voltage stabilizer 25 is also connected to the pre-driver 13 by the sub drive line L7 and the main drive line L6.

The voltage stabilizer 25 adjusts (boosts) the output voltage of the in-vehicle battery 10 or the backup power supply 20 to a voltage (for example, 5 V) at which the pre-driver 13, the authenticator 30, and the controller 40 can stably operate. That is, the in-vehicle battery 10 or the backup power supply 20 supplies electric power to the controller 40, the authenticator 30, and the pre-driver 13 via the voltage stabilizer 25.

The main control power supply line L4 is connected to the charging line L3 on the side of the in-vehicle battery 10 with respect to the charger 21. Similarly, the main drive line L6 is connected to the charging line L3 on the side of the in-vehicle battery 10 with respect to the charger 21. The sub control power supply line L5 is connected to the sub feeder line L2 on the side of the backup power supply 20 with respect to the sub switch element 23b. The sub drive line L7 branches off from the main control power supply line L4 on the side of the controller 40 with respect to the voltage stabilizer 25, and is connected to the main drive line L6.

The power supply device 1 further includes a first diode D1 and a second diode D2, and the first diode D1 is connected to the sub drive line L7 and allows a current to flow only in a direction from the backup power supply 20 toward the pre-driver 13. The second diode D2 is connected to the main drive line L6, and allows the current to flow only in a direction from the in-vehicle battery 10 toward the pre-driver 13 on the side of the in-vehicle battery 10 with respect to a connection point with the sub drive line L7.

### Authenticator

The authenticator 30 performs authentication by wireless communication with a portable device P. Specifically, the authenticator 30 requests the portable device P to transmit authentication information necessary for authentication via a communication device (communication circuit) (not illustrated). The authenticator 30 receives the authentication information from the portable device P via the communication device. The authenticator 30 requests the portable device P to transmit the authentication information and receives the authentication information from the portable device P, and then, the authenticator 30 determines whether the authentication information from the portable device P matches a regular code registered in advance. When determining that the authentication information from the portable device P matches the regular code registered in advance, the authenticator 30 outputs information (signal) indicating that the authentication has succeeded to the controller 40. When determining that the authentication information does not match the regular code, the authenticator 30 outputs information indicating that the authentication fails to the controller 40. The authenticator 30 is implemented by, for example, an electronic control unit (ECU).

### Controller

The controller 40 controls the operation of each part of the power supply device 1. The controller 40 includes, for example, a central processing unit (CPU) or a micro processing unit (MPU) that implements a predetermined function in cooperation with software. The controller 40 may be configured by a hardware circuit such as a dedicated electronic circuit designed to implement a predetermined function or a reconfigurable electronic circuit, or may be configured by various semiconductor integrated circuits. Examples of the various semiconductor integrated circuits include a microcomputer, a digital signal processor (DSP), a field programmable gate array (FPGA), and an application specific integrated circuit (ASIC), in addition to a CPU and an MPU. The controller 40 may include a storage device such as a random access memory (RAM), a read only memory (ROM), and an electrically erasable programmable read-only memory (EEPROM). The storage device temporarily or permanently stores a program for executing charging processing of the backup power supply 20, a program for executing power supply connection processing of switching the supply source of electric power to the motor 12, a program for executing release processing for releasing the door latch device 6, and information used for executing these programs. Electric power is stored in the backup power supply 20, and then, the electric power from the backup power supply 20 is supplied to the authenticator 30 and the controller 40.

### Signal Output Unit

The signal output unit 5 includes a release command output unit 51, a latch state signal output unit 52, an ignition signal output unit 53, and an accident signal output unit 54. The release command output unit 51, the latch state signal output unit 52, the ignition signal output unit 53, and the accident signal output unit 54 may be provided in the power supply device 1 or in the door device 100 including the power supply device 1.

### Release Command Output Unit

The release command output unit 51 outputs a release command. In the present embodiment, the release command output unit 51 is configured by a handle sensor disposed on a door handle of the vehicle V, and outputs a release command, for example, when a user places a hand on the door handle. The release command is a command for electrically executing the release processing of opening the door. The controller 40 acquires the release command, and then, operates the motor 12 to drive the door latch device 6 to open the door (execute the release processing). Note that the release command output unit 51 can also be implemented by a device other than the handle sensor (for example, a switch). The release command output unit 51 is operated by being supplied with electric power from the in-vehicle battery 10 or the backup power supply 20.

The latch state signal output unit 52 outputs a signal indicating a state of the door latch device 6. The latch state signal output unit 52 includes, for example, a push switch attached to a fork 61, a claw 62, or a member coupled thereto.

The ignition signal output unit 53 outputs an ignition signal indicating a state of an ignition switch (not illustrated) of the vehicle V. The ignition signal indicates, for example, an on state when the prime mover (engine) is operating, and indicates an off state when the prime mover (engine) is stopped. The ignition signal output unit 53 may be configured by, for example, an electronic control unit (ECU) mounted on the vehicle V.

The accident signal output unit 54 outputs a signal indicating that the vehicle V is in an accident state. The accident signal output unit 54 includes, for example, an acceleration sensor, a millimeter wave radar, and the like.

The controller 40 is connected to the current detector 14, the in-vehicle battery voltage acquirer 24, the release command output unit 51, the latch state signal output unit 52, the ignition signal output unit 53, and the accident signal output unit 54, and acquires signals (information) output therefrom.

### Door Latch Device

The door latch device 6 is disposed on the door (not illustrated) of the vehicle V. In the door latch device 6, a latch mechanism 60 having the fork 61 and the claw 62 is driven by the motor 12. Specifically, electric power from the motor 12 is transmitted to the claw 62 via a power transmission mechanism (not illustrated), and the claw 62 rotates. The claw 62 rotates, and thus, the latch mechanism 60 is switched between a latch state in which the striker 9 is held and an open state (release state) in which the striker 9 is detachable. The striker 9 is disposed on the vehicle body (not illustrated) of the vehicle V.

Next, the charging processing and the power supply connection processing executed by the controller 40 will be described.

### Charging Processing

The controller 40 controls the charger 21 to execute the charging processing of charging and maintaining the backup power supply 20. Specifically, the controller 40 determines whether to charge the backup power supply 20 on the basis of the ignition signal acquired from the ignition signal output unit 53. The controller 40 determines whether the ignition signal acquired from the ignition signal output unit 53 is in an on state, that is, whether the ignition switch is in an on state.

When determining that the ignition switch is in an on state, the controller 40 controls the charger 21 so that the backup power supply 20 is charged. Note that charging of the backup power supply 20 is continued while the ignition switch is in an on state.

On the other hand, when determining that the ignition switch is in an off state (switched from on to off), the controller 40 determines whether to charge the backup power supply 20 on the basis of the information output from the in-vehicle battery voltage acquirer 24.

Specifically, the controller 40 determines whether the information output from the in-vehicle battery voltage acquirer 24 is less than a first voltage, that is, whether the output voltage of the in-vehicle battery 10 is less than the first voltage. The determination as to whether the output voltage of the in-vehicle battery 10 is less than the first voltage is repeatedly executed while the ignition switch is in an off state.

When determining that the output voltage of the in-vehicle battery 10 is less than the first voltage, the controller 40 controls the charger 21. Specifically, the controller 40 charges the backup power supply 20 so that the motor 12 can output the second voltage with which the motor 12 is at least operable, and maintains the output voltage of the backup power supply 20 to be a second voltage. In the present embodiment, the first voltage is equal to or higher than the minimum output voltage (9 V) of the in-vehicle battery 10, and is, for example, 9 V. The second voltage is less than the first voltage, for example, 3.2 V, which is a voltage in the operation voltage range of 3 V to 8 V of the motor 12. A voltage of 5 V to 6 V of the backup power supply 20 at the time of full charge is greater than the second voltage.

When determining that the output voltage of the in-vehicle battery 10 is greater than or equal to the first voltage, the controller 40 does not charge the backup power supply 20 (does not switch the opening/closing switch of the charger 21).

### Power Supply Connection Processing

The controller 40 controls the switching unit 23 to execute the power supply connection processing of connecting the supply source of electric power supplied to the motor drive unit 11 (motor 12). Specifically, the controller 40 determines the supply source of electric power to the motor 12 on the basis of the information output from the accident signal output unit 54. The controller 40 determines whether the signal output from the accident signal output unit 54 indicates an accident state, that is, whether the vehicle V is in an accident state.

When determining that vehicle V is in an accident state, the controller 40 controls the switching unit 23 such that the supply source of electric power supplied to the motor drive unit 11 (motor 12) becomes the backup power supply 20.

On the other hand, when determining that vehicle V is in a non-accident state, the controller 40 determines whether the output voltage of the in-vehicle battery 10 output from the in-vehicle battery voltage acquirer 24 is less than the minimum output voltage.

When determining that the output voltage of the in-vehicle battery 10 is less than the minimum output voltage, the controller 40 controls the switching unit 23 to set the supply source of electric power supplied to the motor drive unit 11 as the backup power supply 20. As a result, electric power from the backup power supply 20 is supplied to the motor 12. When the controller 40 determines that the output voltage of the in-vehicle battery 10 is not less than a minimum power, neither the in-vehicle battery 10 nor the backup power supply 20 is connected to the motor drive unit 11.

That is, in addition to the case where the vehicle V is in an accident state, even if the vehicle V is in a non-accident state, when the output voltage of the in-vehicle battery 10 becomes less than the minimum output voltage, the backup power supply 20 is charged, and the supply source of electric power to the motor 12 can be the backup power supply 20. As a result, even in a case where battery exhaustion occurs, electric power is supplied from the backup power supply 20 to the motor 12 via the motor drive unit 11. The battery exhaustion means that electric power stored in the in-vehicle battery 10 is reduced and falls below the minimum output voltage necessary for operating the prime mover (engine), and occurs due to an increase in power consumption of the vehicle V, discharge from the in-vehicle battery 10, or the like.

### Release Processing

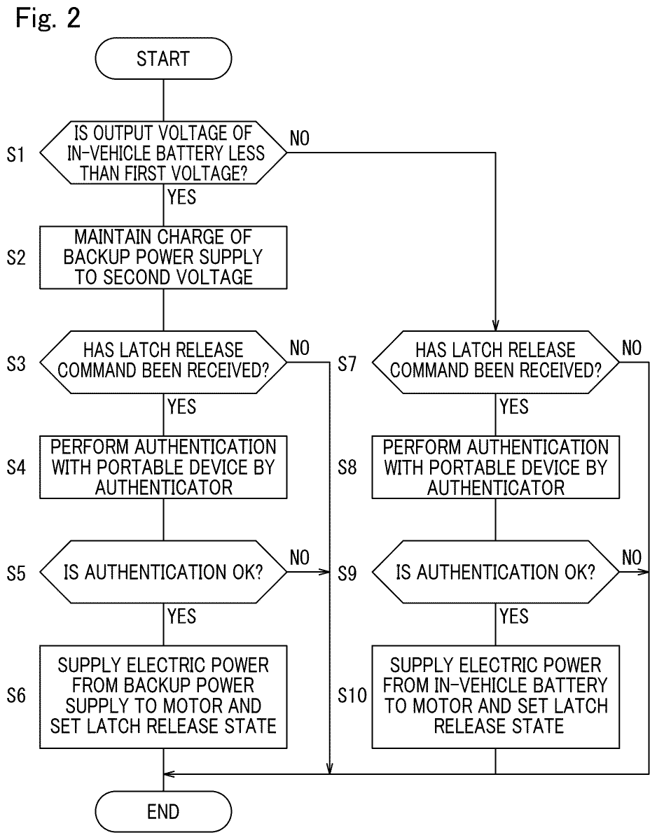

Next, the release processing when a release command is input to the controller 40 will be described with reference to FIG. 2. The release processing is repeated while the ignition switch is in an off state. Note that the release processing includes at least a part of the charging processing and power supply source switching processing described above.

As illustrated in FIG. 2, the controller 40 determines whether the output voltage of the in-vehicle battery 10 detected by the in-vehicle battery voltage acquirer 24 is less than the first voltage (step S1).

When determining that the output voltage of the in-vehicle battery 10 is less than the first voltage (step S1; YES), by controlling the charger 21, the controller 40 charges and maintains the backup power supply 20 until the output voltage of the backup power supply 20 becomes the second voltage (step S2).

Next, the controller 40 determines whether the latch release command has been received by the user placing a hand on the door handle (step S3). When the controller 40 determines that the latch release command has been received (step S3; YES), the authentication processing by the authenticator 30 is executed (step S4). In the authentication processing, the authenticator 30 outputs a signal indicating a result of the authentication to the controller 40.

The controller 40 determines whether the authentication has succeeded on the basis of the signal output from the authenticator 30 (step S5). When determining that the authentication has succeeded (step S5; YES), the controller 40 controls the switching unit 23 such that electric power from the backup power supply 20 is supplied to the motor 12, and brings the door latch device 6 into a release state (step S6), and ends the processing. When determining that the authentication has not succeeded (step S5; NO), the controller 40 ends the processing without bringing the door latch device 6 into a release state.

On the other hand, when determining that the output voltage of the in-vehicle battery 10 is not less than the first voltage, that is, greater than or equal to the first voltage (step S1; NO), the controller 40 determines whether the latch release command has been received (step S7).

When determining that the latch release command has not been received (step S7; NO), the controller 40 ends the processing without bringing the door latch device 6 into a release state.

On the other hand, when the controller 40 determines that the latch release command has been received (step S7; YES), the authentication processing by the authenticator 30 is executed (step S8). Note that electric power from the in-vehicle battery 10 is supplied to the authenticator 30.

The controller 40 determines whether the authentication has succeeded on the basis of the signal output from the authenticator 30 (step S9).

When determining that the authentication has succeeded (step S9; YES), the controller 40 controls the switching unit 23 such that electric power from the in-vehicle battery 10 is supplied to the motor 12, and brings the door latch device 6 into a release state (step S10), and ends the processing. When determining that the authentication has not succeeded (step S9; NO), the controller 40 ends the processing without bringing the door latch device 6 into a release state.

As described in the above embodiment, the backup power supply 20 including the electric double layer capacitor is likely to deteriorate in a state where the capacity is close to the upper limit (hereinafter referred to as a full state). Therefore, in a case where it is not necessary to store electric power in the backup power supply 20, it is preferable that the electric power is discharged and not stored in the backup power supply 20. Since the backup power supply 20 is generally provided as a spare in a case where electric power from the in-vehicle battery 10 is not supplied due to an accident, the backup power supply is configured to be discharged when the ignition switch is an off state. However, in the power supply device 1 according to the above embodiment, even when the ignition switch is in an off state, when the output voltage of the in-vehicle battery 10 detected by the in-vehicle battery voltage acquirer 24 becomes less than the first voltage, the controller 40 charges and maintains the backup power supply 20 to the second voltage at which the motor 12 is at least operable. As a result, even when the output voltage of the in-vehicle battery 10 decreases, that is, so-called battery exhaustion occurs, since the electric power is stored in the backup power supply 20, the motor 12 can be operated by electric power output from the backup power supply 20 to drive the door latch device 6.

In the above embodiment, since the second voltage at least capable of operating the motor 12 is less than the first voltage, the motor 12 can be reliably operated.

In the above embodiment, since the motor 12 is a low-voltage motor operable in a range less than the minimum output voltage of the in-vehicle battery 10, the motor 12 can be more reliably operated.

In the above embodiment, the voltage of the backup power supply 20 at the time of full charge is 6 V, which is greater than the second voltage (3.2 V) with which the low-voltage motor is at least operable. In other words, since the output voltage at the time of full charge (when the backup power supply 20 is charged to the upper limit of the capacity) when the deterioration of the backup power supply 20 progresses is greater than the second voltage necessary for operating the motor 12, even if the backup power supply 20 is charged to the second voltage necessary for operating the motor 12, the deterioration of the backup power supply 20 can be suppressed.

In the above embodiment, the backup power supply 20 is connected so as to supply electric power to the authenticator 30 via the voltage stabilizer 25. Therefore, even in a case where battery exhaustion occurs, authentication by the authenticator 30 can be performed. In particular, the authentication by the authenticator 30 needs to succeed to lock and unlock the door by the door latch device 6. However, even in a case where battery exhaustion occurs as described above, electric power is supplied to the authenticator 30. Therefore, when the authentication succeeds, the motor 12 can be operated to lock and unlock the door.

### Modification

Although the embodiment has been described so far, the above configuration is merely an example, and can be appropriately changed within the scope of the gist of the present invention.

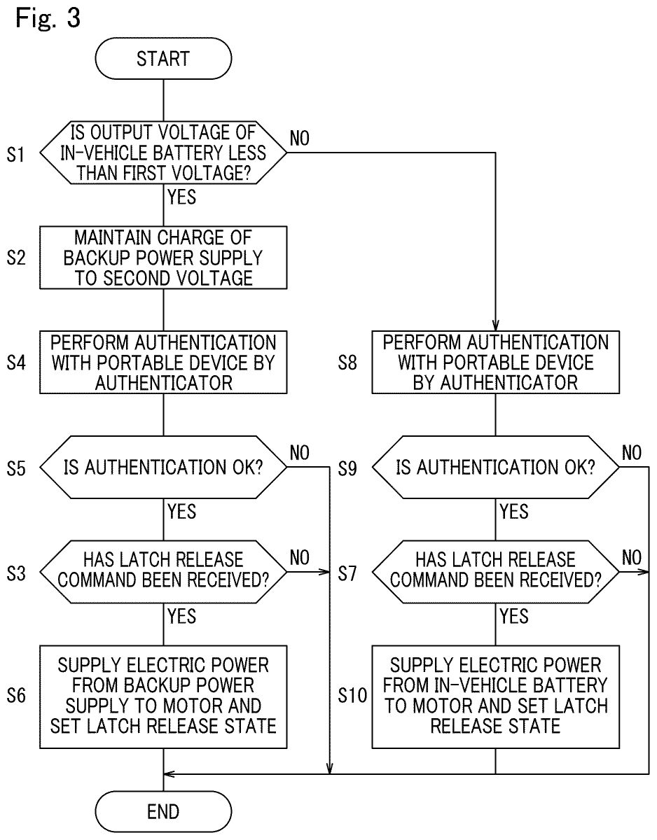

In the above embodiment, a start trigger of the authentication processing by the authenticator 30 is a timing at which the release command is output from the release command output unit 51 (a timing at which the user places a hand on the door handle). However, as illustrated in FIG. 3, the start trigger of the authentication processing may be a timing at which the user having the portable device P enters a communication enabled region and communication between the portable device P and the authenticator 30 is established, for example, a timing at which the authentication information is transmitted from the portable device P in response to an intermittent request for transmission of the authentication information to the portable device P. Note that, in this case, in the release processing illustrated in FIG. 3, timings at which step S3 and step S7 for determining whether the latch release command has been received are different from the timings in the release processing described with reference to FIG. 2. Specifically, step S3 is executed when the controller 40 determines that the authentication has succeeded (step S5; YES), and step S7 is executed when the controller 40 determines that the authentication has succeeded (step S9; YES).

In the above embodiment, the case where the power supply device 1 is applied to the door device 100 has been described. However, the power supply device 1 is also applicable to other devices such as an electric tailgate, an electric fuel lid, and an electric side mirror.

In the above embodiment, the case where the motor 12 is a low-voltage motor has been described. However, the motor 12 is not required to be a low-voltage motor and may be a motor having an operation voltage of 9 V to 16 V.

In the above embodiment, the case where the authentication by the authenticator 30 succeeds and the door latch device 6 operates has been described. However, the authentication processing by the authenticator 30 may be omitted. In this case, the authenticator 30 illustrated in FIG. 1 is omitted, and steps S4, S5, S8, and S9 illustrated in FIGS. 2 and 3 are also omitted.

In the above embodiment, the door latch device 6 has been described as an example of the in-vehicle electric device. However, the in-vehicle electric device may include a device or a mechanism driven by using the power supply device 1 other than the door latch device 6 as a power supply.

What is claimed is

1. A vehicle power supply device comprising:
an in-vehicle battery mounted on a vehicle;
a backup power supply as a spare of the in-vehicle battery;
a motor that drives an in-vehicle electric device by being supplied with electric power from the in-vehicle battery or the backup power supply;
a charger that charges the backup power supply by supplying the electric power from the in-vehicle battery to the backup power supply;
an in-vehicle battery voltage acquirer that acquires an output voltage of the in-vehicle battery; and
a controller that controls the charger, wherein
when the output voltage of the in-vehicle battery becomes less than a first voltage, the output voltage being detected by the in-vehicle battery voltage acquirer, the controller charges the backup power supply so as to output a second voltage with which the motor is at least operable and maintains the output voltage of the backup power supply to be the second voltage.

2. The vehicle power supply device according to claim 1, wherein the second voltage is less than the first voltage.

3. The vehicle power supply device according to claim 1, wherein
the motor is a low-voltage motor operable in an operation voltage range less than a minimum output voltage of the output voltage of the in-vehicle battery, and
the second voltage is a voltage in the operation voltage range.

4. The vehicle power supply device according to claim 2, wherein
the motor is a low-voltage motor operable in an operation voltage range less than a minimum output voltage of the output voltage of the in-vehicle battery, and
the second voltage is a voltage in the operation voltage range.

5. The vehicle power supply device according to claim 3, wherein an output voltage when the backup power supply is charged to an upper limit of a capacity of the backup power supply is greater than the second voltage.

6. The vehicle power supply device according to claim 4, wherein an output voltage when the backup power supply is charged to an upper limit of a capacity of the backup power supply is greater than the second voltage.

7. The vehicle power supply device according to claim 1, further comprising a booster that boosts the output voltage of the backup power supply, wherein
the backup power supply supplies the electric power, via the booster, to an authenticator that performs authentication by wireless communication with a portable device.

8. The vehicle power supply device according to claim 2, further comprising a booster that boosts the output voltage of the backup power supply, wherein
the backup power supply supplies the electric power, via the booster, to an authenticator that performs authentication by wireless communication with a portable device.
